(19) United States
(12) Patent Application Publication
(10) Pub. No.: US 2014/0259400 A1
(43) Pub. Date: Sep. 18, 2014

(54) PATIENT SUPPORT WITH MICROCLIMATE MANAGEMENT SYSTEM

(71) Applicant: Stryker Corporation, Kalamazoo, MI (US)

(72) Inventors: Martin W. Stryker, Kalamazoo, MI (US); Scott Davis, Oshtemo, MI (US); Thomas William Granzow, Plainwell, MI (US)

(73) Assignee: Stryker Corporation, Kalamazoo, MI (US)

(21) Appl. No.: 14/204,026

(22) Filed: Mar. 11, 2014

Related U.S. Application Data
(60) Provisional application No. 61/778,828, filed on Mar. 13, 2013.

(51) Int. Cl. A61G 7/057; A47C 21/04; A47C 31/00

(52) U.S. Cl. CPC A61G 7/057; A47C 31/007; A47C 21/04
USPC 5/421

(57) ABSTRACT

A microclimate management support, for placing under a person's body, includes a flexible breathable upper layer and a generally liquid impermeable intermediate layer beneath the upper layer. An inlet operative to be in fluid communication with the space between the two layers for delivering a gas to the space to control the moisture under the upper layer and increase the wicking of moisture away from the interface between the patient and the upper layer.

### CROSS-REFERENCE TO RELATED APPLICATION

This application claims the benefit of U.S. Provisional Patent Application No. 61/778,828, filed Mar. 13, 2013, which is incorporated herein by reference in its entirety and commonly owned by Stryker Corporation of Kalamazoo, Mich.

### TECHNICAL FIELD AND BACKGROUND OF THE INVENTION

The present invention generally relates to a patient support with a system for controlling at least moisture of a person's skin, especially a bed-ridden person's skin, such as a patient's skin.

When a person's skin is exposed to moisture, elevated temperatures, and/or acidity for prolonged periods of time, the skin can become more susceptible to injury. For example, when a person's skin, already in such a weakened state, is exposed to further stress, such as pressure, the person may be susceptible to developing a pressure sore. Pressure sores can develop when the skin is weakened and subject to pressure, for example, when a person is confined to a supine or seated position for extended periods of time. Therefore, if at least moisture and optionally additionally temperature of a person's skin can be controlled, for example, when the person is confined to a bed or wheelchair for prolonged periods of time, the integrity of the skin may be maintained so that there is a reduced risk of developing pressure sores.

Accordingly there is a need for a system that can allow moisture to be effectively removed between the interface between a patient's skin and their supporting surface (e.g. mattress) and optionally in conjunction with controlling the temperature of the patient's skin.

### SUMMARY OF THE INVENTION

Accordingly, the present invention provides a patient support with a microclimate management system that provides enhanced control over a person's skin moisture and/or temperature to reduce the susceptibility of person's skin to injury.

In one form of the invention, a patient support includes a liquid impermeable cushion and a breathable cover enveloping at least one side of the cushion. The breathable cover is formed from a material that allows moisture to pass through the cover by chemical diffusion wherein the rate of diffusion is controlled by the moisture gradient across the cover. For example, the cover may fully envelope the cushion or simply cover the top side of the cushion, such as in the form of a flat sheet or fitted sheet.

In another embodiment, the patient support includes a liquid impermeable cushion surrounded by a moisture vapor permeable cover, which includes an inlet for coupling to a supply of air for circulating air between the cover and the cushion.

In yet another embodiment, the patient support includes a cushion, which is enveloped in a liquid impermeable layer. The cushion is surrounded by a moisture vapor permeable cover, which includes an inlet for coupling to a supply of air for circulating air between the cover and the cushion.

In a fourth embodiment, the patient support includes a cushion enveloped in an antimicrobial coating or layer. The cushion is surrounded by a moisture vapor permeable cover, which includes an inlet for coupling to a supply of air for circulating air between the cover and the cushion.

In any of the above patient supports, the cover may be formed from a hydrophilic material, which allows moisture through the cover but does not allow viruses or bacteria through the cover.

Alternately, in any of the above patient supports, the cover may be formed from a gas permeable, microporous material that can repel liquid and microparticles, but which allows moisture vapor through.

In a fourth embodiment, the patient support includes a liquid impermeable cushion and a moisture vapor permeable cover formed from a hydrophilic layer. The cushion is surrounded by the moisture vapor permeable cover, which includes an inlet for coupling to a supply of air for circulating air between the cover and the cushion.

In any of the above patient supports, an intermediate layer may be interposed between the moisture vapor permeable cover and the cushion. For example the intermediate layer may be formed from an open cell foam, a three-dimensional (3D) fabric, or a drop stitch fabric or other fabric that provides loft and also space for the air to flow.

In any of the above patient supports, an intermediate layer for delivering and directing temperature and/or moisture controlled air to the person's skin may be interposed between the moisture vapor permeable cover and the cushion. For example, the intermediate layer may be formed by a top sheet for facing in the direction of a person's body, which is joined with a bottom sheet in a manner to form at least one chamber between the respective sheets, and an inlet in fluid communication with the chamber for delivering a gas to the chamber for directing the gas under the patient's body. Positioned between the two sheets is a lofting layer.

In a further aspect, the top sheet and bottom sheet may be joined together to form isolated chambers into which air flow can be directed, and with the top sheet either being formed with or provided with air permeable panels or with apertures to form regions through which air can be selectively flowed to direct air to specified areas of a patient's body.

In any of the above patient supports, the support may include a layer or a flexible or conformable pad that is located beneath the cover but above the cushion and which is adapted to adjust or maintain the microclimate of a person's skin by delivering and directing temperature and/or moisture controlled air to the space beneath the cover and under the person. Further, the layer or pad may be adapted to deliver temperature controlled air while removing excess moisture or wetness. For example, the layer may also be equipped with a moisture absorbing layer to absorb bodily fluids, but which is configured to allow air flow to pass through the moisture absorbing layer.

In yet another form of the invention, a microclimate management system includes a generally moisture vapor permeable upper layer, a liquid impermeable cushion beneath the generally moisture vapor permeable upper layer, and a generally moisture vapor permeable lower layer beneath the liquid impermeable cushion. The system may also include an inlet in fluid communication with the space between the upper and lower layers for directing gas flow between the moisture vapor permeable upper layer and the liquid impermeable cushion, and a fluid supply device in fluid communication with the inlet for directing fluid through the inlet.

In one aspect, the moisture vapor permeable layer may be formed from a hydrophilic layer, which provides the moisture impermeable characteristics.

In a further aspect, the liquid impermeable cushion includes a core, which is enclosed in a liquid impermeable cover to prevent liquid or moisture intrusion into the core.

In any of the above support, the core may include gel, foam, or bladders or a combination thereof.

In any of the above patient supports, an intermediate, lofting layer may be interposed between the moisture vapor permeable upper layer and the liquid impermeable cushion. For example the intermediate lofting layer may be formed from an open cell foam, a three-dimensional (3D) fabric, or a drop stitch fabric or other fabric that provides loft and also space for the air to flow.

In any of the above patient supports, an intermediate layer for delivering and directing temperature and/or moisture controlled air to the person's skin may be interposed between the gas permeable upper layer and the liquid impermeable cushion. For example, the intermediate layer may be formed by a top sheet for facing a person's body, which is joined with a bottom sheet in a manner to form at least one chamber between the respective sheets, and an inlet in fluid communication with the chamber for delivering a gas to the chamber for directing the gas under the patient's body.

In a further aspect, the top sheet and bottom sheet are joined together to form isolated chambers into which air flow can be directed, and with the top sheet either being formed with or provided with air permeable panels or with apertures to form regions through which air can be selectively flowed to direct air to specified areas of the patient's body.

In any of the above patient supports, the support may include a flexible or conformable layer or pad that is adapted to adjust or maintain the microclimate of a person's skin by delivering and directing temperature and/or moisture controlled air to the space between the gas permeable upper sheet and the impermeable cushion. Further, the layer or pad may be adapted to deliver temperature controlled air while removing excess moisture or wetness. For example, the layer or pad may also be equipped with a moisture absorbing layer to absorb bodily fluids, but which is configured to allow air flow to pass through the moisture absorbing layer.

In any of the above patient supports, the support may include one or more inlets in selective fluid communication with a fluid supply, such as a supply of air, for directing air flow into the support to dissipate any moisture than migrates into the support beneath the cover or upper moisture vapor permeable sheet. One inlet may include two fluid passageways, with one of the fluid passageways in fluid communication with one of the region in the support and the other of the fluid passageways in fluid communication with another of the regions. Further, the inlet may be in fluid communication with two sources of gas for directing one of the gases to one of the regions and the other of the gases to another of the regions.

Accordingly, the present invention provides a microclimate management system that provides enhanced control over a person's skin moisture and/or temperature, and further may isolate the cushion from potential bacterial load and viruses other pathogens. Additionally, one or more of the layers surrounding the cushion may be may be disposable, which will help with infection control. It should be understood that part of gas delivery device may be built into support itself, so that the support is a self-contained unit, or can be built into an apparatus, such as a bed, stretcher, cot, operating room table, or a chair, such as a wheelchair, recliner chair, chemotherapy chairs or dialysis chairs.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

These and other objects, advantages, purposes, and features of the invention will become more apparent from the study of the following description taken in conjunction with the drawings.

### DETAILED DESCRIPTION OF THE DRAWINGS

FIG. 1 is a perspective view of a patient support apparatus, for example a hospital bed, with a patient support incorporating a microclimate management system of the present invention;

FIG. 2 is a perspective view of the patient support of FIG. 1;

FIG. 2A is a fragmentary view of the patient support of FIG. 1;

FIG. 2B is a fragmentary side view of the patient support of FIG. 1;

FIG. 3 is an exploded perspective view of the patient support of FIG. 1;

FIG. 4 is an exploded perspective view of another embodiment of a patient support of incorporating a microclimate management system of the present invention;

FIG. 5 is an exploded perspective view of third embodiment of a patient support of incorporating a microclimate management system of the present invention;

FIG. 6 is a perspective view of a patient support apparatus, for example a hospital bed, with a patient support incorporating another embodiment of a microclimate management system of the present invention;

FIG. 7 is a perspective view of the patient support of FIG. 6; and

FIG. 8 is an exploded perspective view of the patient support of FIG. 7.

### DETAILED DESCRIPTION OF PREFERRED EMBODIMENTS

Referring to FIG. 1, the numeral 10 generally designates a patient support of the present invention. In the illustrated embodiment, support 10 is configured as a mattress for use on a bed, such as a hospital bed B, but it should be understood that support 10 may be configured as a pad, for example, for use on a stretcher, cot, or a chair, such as a wheelchair, recliner, chemotherapy chair, or dialysis chair or the like.

As will be more fully described below, support 10 includes a microclimate management system in the form of a system of layers, which allow moisture to flow into the support to draw moisture, as well as heat, away from the patient's skin but which optionally prevents the moisture from flowing into the cushion. For example, the cover may be formed from a material that allows moisture to pass through the cover (i.e. a moisture vapor permeable material) but which does not allow viruses or bacteria to pass through. In this manner the main component of the support, namely the cushion, may be reused without risk of contamination from a patient or the environment, and optionally recovered with a reconditioned or new cover.

Further, in one embodiment, the support may incorporate an air flow system that further facilitates the removal of the moisture and may be used to direct air flow into the support to further facilitate moisture transfer through the cover. While much of the description that follows will make reference to a patient positioned on a bed, it should be understood that the present invention can also be used for people who are simply bed-ridden and not under medical care, and also, as noted, for people seated in chairs.

In the illustrated embodiment, and as best seen in FIGS. 2A, 2B, and 3, support 10 includes a cover 12, which may be formed by an upper sheet 12a and a lower or base sheet 12b joined at their perimeters, for example, by a zipper 12c. Sheets 12a and 12b are formed from a moisture vapor transfer capable fabric. Further, sheets 12a and 12b may be formed from a non-porous lamination that prevents bacteria and viruses to pass through. A suitable material is a hydrophilic material available from Dartex Coatings Limited. Alternately, the cover may be formed from a gas permeable microporous material that can repel liquid and microparticles, but which allows moisture vapor through, such as a hydrophobic material available from Gore.

Thus, cover 12 is a flexible, breathable cover that allows water vapor to flow into and through the upper sheet so that it can be dissipated, as will be more fully described below. In the case of a cover made of hydrophilic material, the driving force moving the moisture molecules through the cover is the relative heat and humidity on one side of the cover compared to the opposed side of the cover, with the warm air flowing to the cooler dry air due to the pressure differential. In this manner, when the patient's skin is warming up and becoming moist, the moisture and heat will flow away from the patient's skin and into and through the cover into support 10.

Referring again to FIGS. 2A, 2B, and 3, support 10 also includes a cushion 14 inside cover 12, which is adapted to be liquid impermeable. In the illustrated embodiment, cushion 14 includes a core 16, which may be formed from gel, foam, or one or more bladders or a combination thereof, and a liquid impermeable cover or layer 18 (FIG. 2B), which envelopes core 16. Cover 18 may be formed from a layer of liquid impermeable material, which forms the liquid impermeable barrier around core 16.

For example, cover 18 may be formed from two or more sheets of liquid impermeable material that are joined together, such as by heat sealing or the like, to form the barrier around core 16. For example, the sheets forming cover 18 may be joined and sealed at their respective perimeters. For example, suitable materials include coated nylon or coated polyester, TYVEK or GORTEX. Thus, cover 18 may comprise a flexible, liquid impermeable cover.

Positioned between cover 12 and cushion 14 is an optional intermediate layer 22. Intermediate layer 22 may be fluid permeable and, further, form a space between the cover and the cushion to allow gas to flow through support 10. To allow air flow to be introduced into support 10, support 10 includes one or more inlets 24, which are in fluid communication with the chamber formed between the cover and the cushion, and which is used to direct gas flow into support 10 and, further, into intermediate layer 22. Inlet 24 may be formed from a tubular member inserted and secured between upper sheet 12a and base sheet 12b or may be formed from the fabric forming the upper sheet and/or the base sheet. Furthermore, inlet 24 may include a valve (not shown), such as a check valve, so that if the blower (described below) is turned off, the air that is directed into the support 10 will remain in support 10 until the air is discharged through zipper 12c, also described below.

Intermediate layer 22 may extend the full length of the sheet and fill the entire space between the cover and cushion or may be located, for example, only over a discrete region where a patient may be positioned so that intermediate layer 22 will maintain a space between the cover and the cushion at least under the patient to allow gas to flow through the support under the patient. Intermediate layer 22 may be formed from a variety of different materials, including a conventional lofting material, a 3-D fabric, or a screen material with off-set regions or points to allow airflow across and through the screen. For example, the screen may be molded from a polymeric material. In these forms, intermediate layer 22 is generally non-crushable so that air may flow across the intermediate layer even when a patient is laying on top of the sheet. Another suitable material for intermediate layer includes a drop-stitch, which when inflated forms an air permeable layer, but when un-inflated compresses back to a relatively impermeable layer. In addition, intermediate layer 22 may be formed with channels or may be segmented into channels (such as described below) so that air is directed through support 10 in channels to better direct the flow of air through support and better target specific areas under the patient's body, which may need greater wicking away of moisture. Thus, intermediate layer 22 may comprise an intermediate, fluid permeable and/or lofting layer.

As best understood from the figures, when a patient is positioned on support 10, and air is directed into the support, air will flow through the space between the cover and the cushion and optionally into intermediate layer 22, which will maintain the space between the cover and the cushion so that air can flow through the support and underneath the patient's body. The air and moisture will then exit support 10 through zipper 12c. The temperature of the airflow is controlled to maintain the temperature of the space beneath cover 12 to a lower temperature than at the interface between the patient's skin and cover 12 to provide a moisture and/or temperature gradient that will continue to encourage moisture to migrate away from the interface with the patient through cover 12 for dissipation in support 10 and thereby enhance the wicking away of moisture from the patient's skin to maintain the patient's skin to a desired dryness level.

To deliver air flow into support 10, as noted above, support 10 or the support structure, such as bed B, includes a control system 30 (see FIG. 1 for example), which includes an air delivery device 32, such as a blower. The blower may be used to selectively or continuously deliver air to support 10. In addition, the air delivery device may include more than one blower. Further, the blower may be housed in a separate housing (34) such as shown, or may be built into the support or into the bed, for example, in the head or footboard.

In the illustrated embodiment, housing 34 is adapted to removably mount to a support surface, such as a bed, including to the footboard, and supports a controller for operating the blower. The blower may be a conventional blower and further optionally blows air across a heating/cooling unit (not shown) so as to provide cool or warm air, which may be desirable in some circumstances. The heating/cooling unit may include a Peltier effect device, which will either heat or cool air depending on the polarity of current provided by the controller. For further details of a suitable Peltier device reference is made to co-pending application Ser. No. 12/899,059, filed Oct. 6, 2010, entitled MICROCLIMATE MANAGEMENT SYSTEM, which is incorporated by reference and which is commonly owned by Stryker Corporation of Kalamazoo, Mich.

As best seen in FIGS. 1, 2, and 3, the air delivery device 32 is in fluid communication with support 10 via one or more conduits 40 formed from conventional tubing, such as plastic tubing, which may comprise a single lumen tubing or multiple lumen tubing should the support need multiple inputs, more fully described below. Further, housing 34 may support user interface devices 36 (see FIG. 1), such as buttons or touch screen or the like, to allow a user to control the operation of the blower, and further to select the temperature and, optionally, further to select the flow rate of the air flowing into the sheet. In addition, housing 34 may house a power source, such a battery, including a rechargeable battery, for powering the blower and the heating and cooling device or may simply have a power cord for plugging into the bed power supply or an AC wall outlet.

Alternately, air delivery device 32 may simply comprise a conduit for delivering air to the sheet from an onboard air supply at the bed, such as described in copending application Ser. No. 12/057,941, filed Mar. 28, 2008, entitled PATIENT SUPPORT WITH UNIVERSAL ENERGY SUPPLY SYSTEM, which is incorporated by reference in its entirety, which is commonly owned by Stryker Corporation of Kalamazoo, Mich.

Although previously described as a cover that envelopes cushion 14, the cover may simply cover one side of the cushion such as shown in FIGS. 4 and 5. For example, the cover may be provided in the form of a fitted sheet 12′, which envelopes the intermediate layer 22 and cushion 14 (on at least on the top side and edges of cushion 14). Referring to FIG. 5, the cover may be configured in the form of a flat sheet 12″ which covers lofting layer 22 and cushion 14 and includes downwardly depending portions for tucking under the cushion.

Referring to FIGS. 6-8, the numeral 110 generally designates another embodiment of the support. Support 110 similarly includes a cover 112 and a cushion 114, enclosed by cover 112, which is of similar construction to cover 12 of the first embodiment. Therefore, reference is made to cover 12 for further details. Support 110 also includes an intermediate layer 122, but which is zoned to direct the air flow coming into support 110 to discrete areas of a patient's body. For example, intermediate layer 122 may be formed by an upper sheet 122a and a base sheet 122b with a spacer sheet between the upper sheet and the base sheet. The zones may be formed by seams, for example by welds, between the upper layer 122a and the base layer 122b, which form a plurality of regions, for example regions 122c, 122d, 122e, 122f, and 122g. Further, the upper and base sheets may be formed by impermeable sheets with apertures or semipermeable sheets, which control the flow of air from layer 122. The regions, therefore, provide a fluid directing function—either independent from the others or together with one or more regions so that different zones of support 110 may be circulated with air of differing temperatures or flow rates to either cool or warm the discrete areas of the patient. As understood, therefore, each zone may be formed by one or more regions. Each region 122c, 122d, 122e, 122f, and 122g may be in fluid communication with a respective fluid conduit 140c-140g for coupling via inlets 124 to one or more air supplies. For example, each lumen of conduits 140c-140g may be in fluid communication with air delivery device 32, which is controlled by the controller of control system 30. Alternately, more than one air supply device may be used and controlled by way of valves, mechanically or electromechanically operated valves, such as solenoid valves or a valve manifold, for example a solenoid valve manifold, with the controller opening and closing the valves based on input from a user or a treatment protocol, for example, stored in the controller. Where two or more air delivery devices are used, the air delivery devices may be separately controlled and further may each have a heating/cooling unit so that air may be delivered to one area at one temperature, and air at a second temperature may be supplied to another area. For example, one air delivery device may provide cold air with the other delivery device providing hot or warm air. In this manner, the support may be customized to supply different temperatures along its length and over different regions of the support.

As noted above, similar to layer 22, intermediate layer 122 is adapted to form an air delivery layer. For example, intermediate layer 122 may be formed from an impermeable material or a semi-permeable material with highly permeable portion or sections. For example, the highly permeable portions may be provided by apertures formed in the layer or may be formed by a section of another fabric with a larger weave so that the fabric is porous. Optionally, where intermediate layer 122 is formed from a substantially impermeable layer, layer 122 may be provided with a semi-permeable portion, such as GORTEX insert, which allows air to pass through but prevents liquid from flowing back through the layer, for example, in the case of an incontinence episode. The permeable portion or region may be confined to a single or multiple discrete locations. For example, it may be desirable to have one location that generally would coincide with the hip and buttock region of a patient and another at the heel area of the patient, where the pressure on a patient's skin may be highest depending on the patient's body type and the mattress configuration.

In a similar manner, each region 122c-122g of intermediate layer 122 may have a different pattern of holes or apertures or different permeability, again to tailor the airflow to the space in cover 112. In addition, to allow a user to modify intermediate layer 122 to a particular patient's needs, the sheet may have removable covers (e.g. removable impermeable covers) that close off the respective areas or zones as air delivery areas so the user may select which area to open. Or the zone/area control may be achieved through the controller.

While each of the embodiments of the supports have been described in reference to providing a wicking layer as well as an optional air supply, it should be understood that additional layers may be provided, such as an antimicrobial layer, for example, over the cushion (14 or 114) or cover (12 or 112).

It can be appreciated from the above description, the cover and lofting layer may be removed for cleaning or disposal. The surface of the cushion (14 or 114) can then be cleaned, if not protected by an antimicrobial layer or coating or cover, so that it can be reused. Thus, support may be formed from a combination of disposable components and reusable components, which may help with infection control.

Additionally, the housing containing the fluid delivery devices of any of the above embodiments may incorporate connectors or ports, such as USB ports, for plugging other devices into the housing for providing additional functionality, for example, for powering other devices, for example including lights, worn for example by a surgeon.

While several forms of the invention have been shown and described, other changes and modifications will be appreciated by those skilled in the relevant art. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property right or privilege is claimed are defined as follows:

1. A support for placing under a person's body, said support comprising:
a breathable cover;
a liquid impermeable cushion enveloped by said cover at least on one side of said cushion; and
wherein the flexible cover is adapted to allow moisture to pass through the cover but limit the transfer of bacteria or viruses through the cover.

2. The support according to claim 1, further comprising an inlet operative to be in fluid communication with a supply of gas and in fluid communication with a space under the cover and above said cushion.

3. The support according to claim 1, wherein said cover is a fitted or flat sheet.

4. The support according to claim 1, further comprising a permeable spacer layer, said permeable spacer layer interposed between said cover and said cushion.

5. The support according to claim 4, said permeable spacer layer comprising a screen, an open cell foam, a three-dimensional (3D) fabric, or a drop stitch fabric.

6. The support according to claim 4, wherein the permeable spacer layer has a substantially uniform thickness.

7. A support for placing under a person's body, said support comprising:
a liquid impermeable cushion;
a moisture vapor permeable cover enveloping said cushion; and
an inlet for directing air into a space between said cover and said cushion.

8. The support according to claim 7, wherein said moisture vapor permeable cover comprises a hydrophilic material.

9. The support according to claim 7, wherein said cushion comprises a gel, a foam, or a bladder or a combination thereof.

10. A support for placing under a person's body, said support comprising:
a moisture vapor permeable upper layer;
a liquid impermeable layer;
a moisture vapor permeable base layer, said liquid impermeable interposed between said upper layer and said base layer, said upper layer forming a skin facing surface for facing the person's body; and
an inlet for directing gas flow under said upper layer and above said liquid impermeable layer for increasing the diffusion of moisture through said upper layer.

11. The support according to claim 10, further comprising an intermediate lofting layer over said liquid impermeable layer.

12. The support according to claim 11, wherein the inlet is in fluid communication with said intermediate lofting layer for directing gas flow into said intermediate lofting layer.

13. The support according to claim 12, wherein said intermediate lofting layer forms at least two discrete chambers, and said inlet is in communication with at least one of said chambers.

14. The support according to claim 13, wherein said inlet includes two fluid passageways, one of said fluid passageways in fluid communication with one of said chambers and the other of said fluid passageways in fluid communication with another of said chambers.

15. The support according to claim 13, wherein said inlet comprises a first inlet, said support having a second inlet in fluid communication with another of said chambers.

16. A method of reducing moisture at an interface between a patient's skin and a patient support comprising:
supporting a patient on a cushion;
forming a barrier between the patient's skin and the cushion, the barrier allowing water vapor to penetrate through the barrier by diffusion; and
controlling the moisture between the barrier and the cushion to control the diffusion of water vapor through the barrier to thereby wick away moisture at the interface between the patient' skin and the barrier.

17. The method according to claim 16, further comprising spacing the barrier above the cushion.

18. The method according to claim 16, wherein said controlling the moisture comprises directing air flow between the barrier and the cushion.

19. The method according to claim 17, wherein said spacing includes providing an intermediate lofting layer between the barrier and the cushion.

20. The method according to claim 19, further comprising directing the air flow into the intermediate lofting layer.

21. The method according to claim 20, wherein the intermediate lofting layer includes a plurality of regions, each region being independent from the other region, and each region being adapted to direct air flow to a selected area of the patient's body.
